(19) United States
(12) Patent Application Publication
(10) Pub. No.: US 2024/0328898 A1
(43) Pub. Date: Oct. 3, 2024

(54) Method and device for acoustic wear measurement of linear or rotary drives

(71) Applicant: Jenny Science AG, Rain (CH)

(72) Inventor: Alois JENNY, Hildisrieden (CH)

(21) Appl. No.: 18/622,443

(22) Filed: Mar. 29, 2024

(30) Foreign Application Priority Data
Mar. 30, 2023 (DE) 10 2023 108 131.4

(51) Int. Cl. G01M 13/045; H02K 41/02

(52) U.S. Cl. CPC G01M 13/045; H02K 41/02; H02K 2211/00

(57) ABSTRACT

A method for fault prevention in electric drives in industrial automation, including recording sound level signals inside of the electric drive during operation with known sound propagation geometry and known distance to the source of sounds, continuously comparing the sound power with a reference sound power and monitoring of the exceeding of the maximum value of the sound energy, continuously adding up the sound power over time when the sound power exceeds the reference sound power, continuously subtracting the sound power over time when the sound power falls below the reference sound power, with a minimum value of zero, and generating a warning or alarm when the maximum value of the sound energy is exceeded.

The subject matter of the invention is a method and a device for acoustic wear measurement of electrically driven linear or rotary drives according to the generic term of patent claim 1. Linear electric drives are known, for example, from EP1 732 197 B1, of the same applicant. The publication shows a magnetically driven linear motor carriage which can be moved in the longitudinal direction on a guide rail, wherein a number of energized magnetic windings are present in the linear motor carriage, which interact with permanent magnets arranged in the guide rail.

The linear motor, which can be inferred from the own patent EP1 732 197 B1 of the applicant, has proven itself on a large scale and has a long service life. However, there is a need to check the service life of the bearing elements and, if necessary, to issue a warning if the bearing elements subject to friction wear out. There is also a need to recognize when lubrication of the bearing elements is necessary and to carry it out in order to increase the service life.

By recording and evaluating the sound energy, possible sources of errors can be recognized and diagnosed at an early stage before they lead to major faults. The continuous monitoring of sound energy helps to prevent failures and extend the operating time and service life of electric drives.

The carrying out of acoustic wear measurements is known, wherein the sound pressure is also used as an evaluation criterion; this can be seen, for example, in US20180115226A1. The disadvantage of this known wear measurement is that a complex evaluation of the sound signal must be carried out, which is associated with a high electronic complexity and does not exclude the possibility of false alarms, inasmuch as external noises can falsify the measurement results of the sound generator and lead to incorrect results with regard to wear.

Typical failures of electric drives are due to mechanical wear of guide and bearing elements. A lack of maintenance (lubrication) can also cause premature mechanical wear and result in the failure of the electric drive. In the run-up to a failure, an increase in sound energy can almost invariably be determined.

Experience has shown that the sound energy increases continuously when a defect becomes apparent. The sound energy also increases in the absence of lubrication. If the sound energy exceeds a predefined limit, a warning or alarm can be issued. The sound power must be known in order to calculate the sound energy. The sound power of a source of noise can be calculated using the distance to the sound pressure sensor (microphone) and the propagation geometry of the sound. These two parameters, distance to the sound pressure sensor and propagation geometry, are known if the sound pressure sensor is installed in the electric drive.

The sound power can, moreover, also be recorded when the drive is at a standstill, which is to say, the ambient sound power. This can then be subtracted from the sound power during operation to obtain the power of the wear-relevant source of sounds.

Newly arising noises that indicate an impending fault can only be inadequately recorded by a simple sound pressure measurement. An external noise impulse could furthermore be misinterpreted and trigger an alarm.

Some such analysis methods are used today. This requires various sophisticated algorithmic evaluations, which have recently been supported by artificial intelligence. Such evaluations, such as pattern recognition, wavelet transformation, statistical methods or machine learning, are complex and only worthwhile for larger systems.

The invention is therefore based on the task of designing a method and a device for acoustic wear measurement of linear electric drives in such a way that a cost-effective, simple and reliable wear measurement on linear electric drives is possible.

In order to solve the task set, the invention is characterized by a method and a device carrying out the method according to the independent patent claims.

Since the distance and propagation geometry of the sound within the electric drive are known, the calculation of the sound energy using the sound power is easy to accomplish and does not require a great deal of computing power. The recording of the sound energy is therefore an inexpensive method that can also be used for individual components such as electric drives in industrial automation.

As a first step, a reference sound power level is defined that corresponds to normal operation. As a second step, a maximum sound energy value is defined, above which a warning or alarm can be triggered.

If the sound power remains the same or lower than the reference sound power value, then no sound energy value is calculated. If the reference sound power value is exceeded, this positive out-of-limit value is integrated over time and thus a sound energy value is continuously added up. If there is a value that is once again below the reference sound power value, this negative out-of-limit value is also integrated over time and continuously subtracted from the previously positive out-of-limit sound energy value. In normal operation, the maximum sound energy value is not reached or not exceeded. At the same time, the sound power may exceed the reference sound power value over a certain period of time. With increasing wear, the sound power will increase and exceed the reference more and more often, thus reaching the maximum sound energy value. From this state onwards, a warning or an alarm must be issued in order to prevent an expected failure.

A particularly preferred configuration of the invention provides for a method which is characterized by the following steps:
1. A method for fault prevention in electric drives in industrial automation, preferably comprising the steps of:
   Recording of sound level signals on the inside of the electric drive during operation with known sound propagation geometry and known distance to the source of sounds.
   Continuous comparison of the sound power with the reference sound power and monitoring of the exceeding of the maximum value of the sound energy.
   Continuous adding up of the sound power over time when the sound power exceeds the reference sound power.
   Continuous subtraction of the sound power over time when the sound power falls below the reference sound power, with a minimum value of zero.
   Generation of a warning or alarm when the maximum value of the sound energy is exceeded
2. A system for carrying out the procedure referred to in point 1, comprising:
   A sound level sensor for recording the sound level signals
   Continuous calculation of the sound power with monitoring of the level and integration with the exceeding sound energy.
   Monitoring of the exceeding sound energy and triggering of a warning or alarm when the maximum sound energy is reached

The subdivision of this preferred method into individual method steps leads to the following technical teaching:

Method for acoustic wear measurement of electrically driven linear or rotary drives for recording wear-related damage to bearing elements,
(1) wherein in a first method step, the sound power is recorded with at least one acoustic sound receiver,
(2) wherein, in a second method step, the recorded sound power is continuously compared with a maximum permissible reference sound power,
(3) wherein, in a third method step, a temporary exceeding of the reference sound power is recorded, and
(4) in a fourth method step, a continuous integration by addition of the sound power recorded in the third method step is carried out over time, as long as the sound power exceeds the reference sound power,
(5) wherein, in a fifth method step, a continuous integration by subtraction of the of the sound power recorded in the third method step is carried out over time when the sound power falls below the reference sound power,
(6) wherein in a sixth method step, the additive and subtractive integral surfaces determined in the fourth and fifth method steps are summed to form a summation curve, and
(7) wherein, in a seventh method step, a warning message and/or a triggering of an alarm takes place if the summation curve (38) determined in the sixth method step is greater than zero over a specified period of time.

The invention uses the following preferred definitions:
1. Sound level: the sound pressure generated by a source of sounds that can be measured by means of a microphone
2. Sound power (of the source): Calculable by means of the sound level at a known distance and acoustic propagation geometry (these parameters are provided by our own construction of the direct drive)
3. Sound energy: sound power x time, which is to say, integration of sound power over time.
4. Reference sound power: threshold of the sound power: if the sound power is higher, it is added to the sound energy over time; if the sound power is lower, it is “subtracted” from the sound energy, here too over time
5. Maximum sound energy value: The sound energy builds up and decreases continuously during normal operation, depending on the speed and load of the drive according to the above calculation. In normal operation, it is therefore between 0 and less than the maximum value.

If wear becomes apparent, the sound energy exceeds the maximum value. What is interesting about this method is that this sound energy value can be calculated continuously and no backward calculation over a past period of time is required. Likewise, no analysis of the sound vibration (amplitude, frequency, pattern recognition, machine learning, etc.) is required, as shown in US20180115226A1.

The novel method does not consider an accumulated sound energy over a period of time. Due to the preceding comparison of the sound power with a reference value before the integration, the sound energy does not always become greater, but rather is continuously counted up and down. There are no time periods, the process runs continuously. Only when wear occurs does the integrated sound energy drift upwards, leading to an alarm or warning.

The sound pressure (S1) of the guide system of a direct drive (linear or rotary) is recorded and the sound power is calculated from this in the acoustic model (S2). The acoustic model (S2) takes into account the sound-relevant mechanical conditions and the distances to the sources of sounds in order to determine the sound power from the sound pressure.

This calculated sound power is compared with the reference sound power using a comparator (C1). The resulting sum (positive or negative) is integrated over time and thus summed up and down as sound energy.

Our method does not consider an accumulated sound energy over a period of time. But rather, by means of the comparison of the sound power with a reference value before integration, the sound energy does not always increase, but rather is continuously added and subtracted.

In a preferred configuration of the invention, it is provided that the wear measurement takes place on the moving linear motor carriage and not in or on the stationary guide rail. The arrangement of the sound receiver in the moving part, namely in the linear motor carriage or in the rotor of a rotary electric drive, is particularly advantageous. If the following description only describes the advantages and measures for linear drives, this is not to be understood as restrictive. All features and properties also apply analogously to rotary electric drives.

The arrangement of the sound receiver in the moving part of the drive has the advantage that a wear measurement takes place directly at the location of the bearing elements installed in the linear motor carriage.

It has been found to be particularly advantageous in the case of a U-shaped profiled linear motor carriage to arrange at least one sound receiver on the inner side of one U-leg, directly adjacent to the opposite fixed linear rail.

It would be obvious, for example, to arrange the sound receiver on the fixed linear rail, however this would be combined with the disadvantage that the sound receiver would be directly affected by disturbing ambient noise. Moreover, it is then separated from the bearing elements on the carriage side by an air gap, which negatively affects the precision of the sound recording.

The arrangement of the at least one sound receiver on the inner side of the U-leg of the linear carriage results in a special shielding against ambient noise, inasmuch as the sound receiver is concealed on the inner side of the U-leg, covered by the stationary linear rail with sound insulation to the outside and is therefore not visible from the outside, making it difficult for the interfering ambient noise to reach it. This keeps the recording of sound power largely free of disturbing ambient noise.

The arrangement of the sound receiver on the moving part-which holds the bearings-also means that wear noises from the bearing elements are not only recorded via airborne sound propagation, but also via structure-borne sound propagation.

It has proven to be advantageous that the wear measurement is carried out in the space between two bearing elements on the moving part, which bearing elements are spaced apart from one another in the longitudinal direction, wherein it is preferred that a single sound receiver is arranged in this space, in the area of a side wall, and, at the same time, at a distance from the single sensor, a microprocessor that processes sound events, so that the two components are arranged directly adjacent to one another and are only arranged on a side wall of the linear motor carriage in the space between two bearing elements. This has the advantage that the two parts, namely the sound receiver and the microprocessor, are connected directly through the side wall to a connector housing arranged outside the side wall, in which connector housing a communication interface is arranged, which transmits a signal output to an alarm transmitter via a connected plug using an assigned protocol.

The given technical teaching results in a particularly simple construction, inasmuch as it is sufficient to arrange such a sound receiver on a single (preferably inner) wall of the linear motor carriage and to arrange a microprocessor in the vicinity on the same side, which microprocessor evaluates the sound result.

If the bearing elements of the linear motor carriage wear on the opposite side, this is communicated to the sound receiver arranged on the other side via the structure-borne sound of the linear motor carriage and via airborne sound, in this way it is sufficient in the method according to the invention, if one of the four bearing elements shows wear, inasmuch as a triggering of an alarm preferably then takes place. There is therefore no need to specify the direction or location in which a bearing element is worn, inasmuch as the sound release of a single bearing element is sufficient to consider the linear motor carriage to be in need of maintenance and/or unusable and to recognize the end of its service life.

In this case, it is possible to replace individual bearing elements or to replace the entire linear motor carriage as a whole with a new one that comprises new, unused bearing elements.

Of course, if a wear measurement exceeds a certain specified maximum value, it is also possible that the associated guide rail is also replaced inasmuch as the tracks of the guide rail in the worn bearing elements are worn out and must also be replaced.

The technical teaching therefore has the advantage that a simple wear measurement on a magnetically movable linear motor carriage or an electromagnetically driven rotor can be used to recognize wear economically and easily.

In the method, it is preferred if a comparison with a reference power is carried out, inasmuch as in a first method step a switching pressure meter sends its signal to a sound power module, which adds up the sound power and sends it to a calculation module, where the added-up result is compared with a further value, namely with a reference sound power provided by a reference module. The reference sound power is subtracted from the added up sound power of the sound pressure meter and the sum of the addition and subtraction is, always and over the entire time, inputted to an integrator, the value of which moves in a positive or negative direction depending on the sound pressure. When this sound energy determined in the integrator, which can be positive or negative, is inputted to a comparator module, which constantly compares the integral value with a defined maximum value, an alarm is triggered only when a certain comparison value is exceeded, which means that the wear is unusually high and the linear motor carriage or its bearing elements need to be replaced.

That which is important is that the system runs continuously and always remains installed in its guide rail throughout the entire service life of the linear motor carriage and measures continuously, which is to say, there is a continuous measurement and not a periodic measurement, as is known in the state of the art. There is therefore no comparison with a predetermined pattern and no frequency analysis is necessary, but rather simply an addition of the sound power recorded by a sound receiver on a side wall of the linear motor carriage.

The subject matter of the present invention results not only from the subject matter of the individual patent claims, but also from the combination of the individual patent claims with each other.

All the information and features disclosed in the documents, including the abstract, in particular the spatial configuration shown in the drawings, could be claimed as essential to the invention insofar as they are new, either individually or in combination, when compared to the prior art. The use of the terms “essential” or “according to the invention” or “essential to the invention” is subjective and does not imply that the features so designated must necessarily form part of one or more patent claims.

The invention is explained in more detail hereinafter with the aid of a drawing, which only shows one implementation. The drawing and its description show further features and advantages of the invention that are essential to the invention.

Wherein:

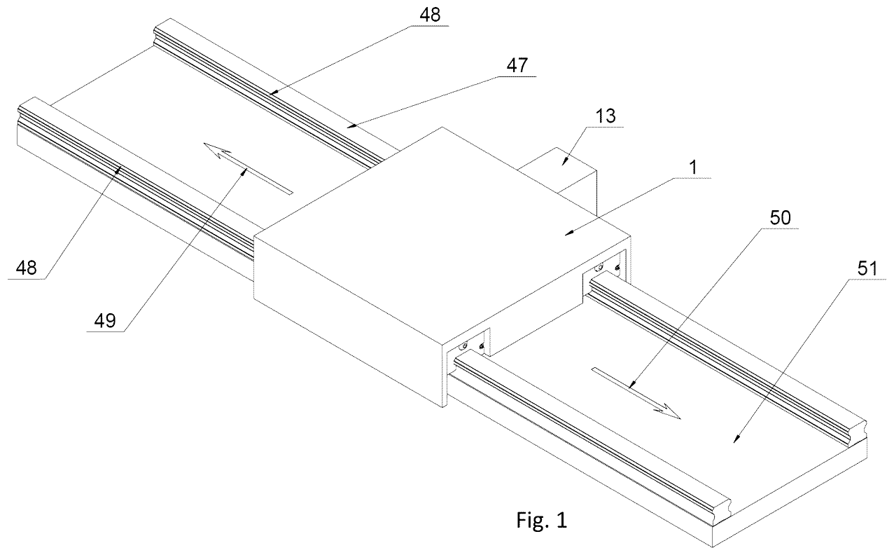

FIG. 1: Shows a perspective view of a linear motor axis consisting of a linear motor carriage, which is driven in longitudinal direction on a fixed guide rail.

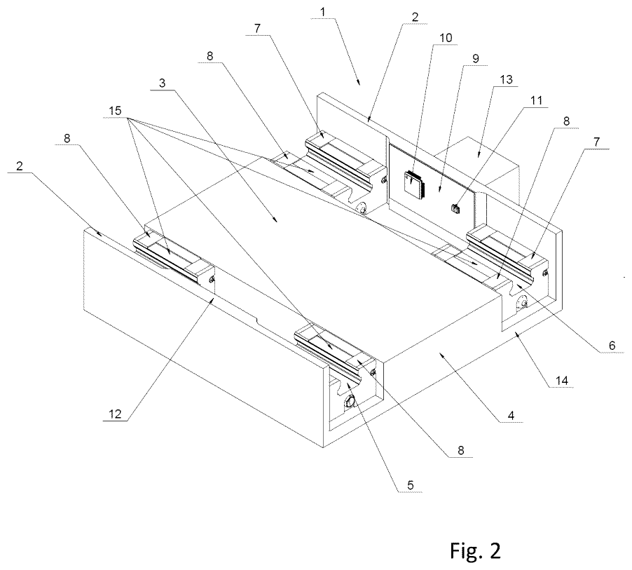

FIG. 2: Shows the inner side of the linear motor carriage according to FIG. 1.

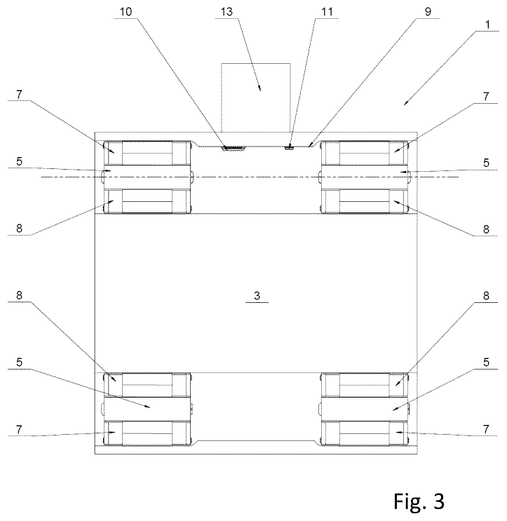

FIG. 3: Shows the top view of FIG. 2 of the linear motor carriage.

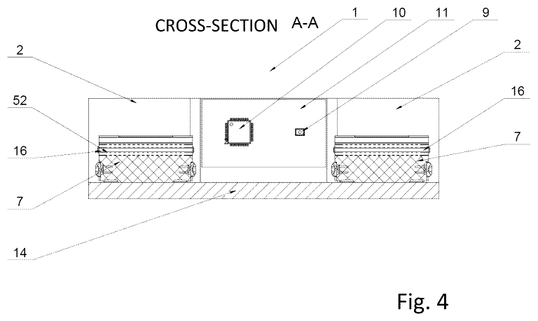

FIG. 4: Shows the cross-section along line A-A in FIG. 3, showing one side wall of the linear motor carriage.

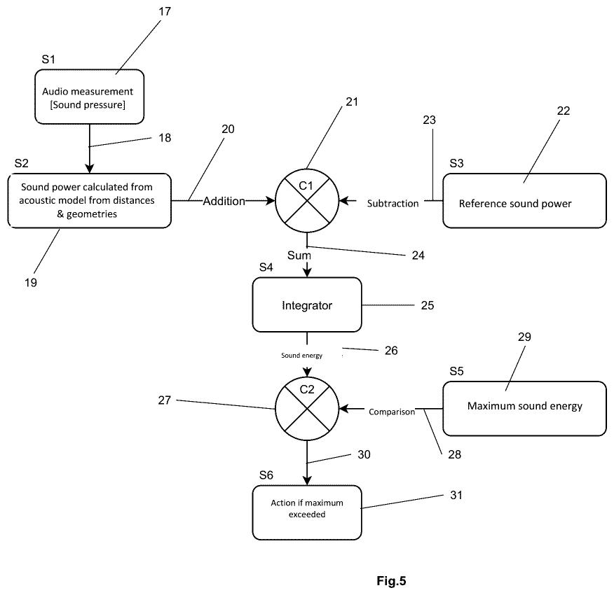

FIG. 5: Shows a schematic block diagram of the evaluation of the sound receiver signals.

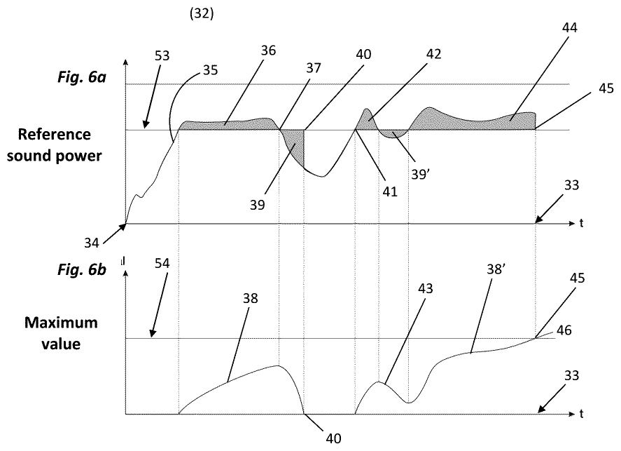

FIG. 6a: Shows the representation of the sound power in comparison to a reference.

FIG. 6b: Shows the representation of the integration or summation of the integrated surfaces according to FIG. 6a.

A linear motor axis consisting of a linear motor carriage 1 is generally shown in FIG. 1, which linear motor carriage is driven on a stationary guide rail 47 so as to be displaceable in the arrow directions 49, 50, wherein lateral tracks 48 are provided in the guide rail 47, which engage in associated bearing elements 7, 8 on the inner side of the linear motor carriage 1.

FIG. 2 and FIG. 3 show further details of the inner side of the linear motor carriage, wherein the linear motor carriage 1 consists of a metal part which essentially comprises a base plate 14, on which two side walls 2, 2 are arranged parallel to each other and at a distance from each other. A winding housing 4, which forms an inner winding surface 3, is arranged on the inner side of the base plate 14. A number of windings, which preferably consist of copper wires and are electrically energized, are arranged in the winding housing 4.

Due to the electrical current supply, it is possible to realize a propulsion of the linear motor carriage 1 in the arrow directions 49, 50 on the guide rail 47, inasmuch as a number of permanent magnets 51 are arranged on the guide rail 47, which in FIG. 1 are concealed by an upper cover.

According to FIG. 2 and FIG. 3, opposite and parallel guide tracks 5, 6 are arranged on the inner side of the linear motor carriage 1, which guide tracks are laterally delimited by respective bearing elements 7, 8. It is preferable if an opposing bearing element 7, 8 is respectively arranged on the inlet and outlet side of the linear motor carriage 1, so that a total of four bearing elements form the guide device for the linear motor carriage 1 on the guide tracks 48 of the guide rail 47.

Each bearing element 7, 8 consists of recirculating ball bearing guides, which means that a series of ball bearings are arranged on a closed elliptical track and roll one after the other on the guide track 48 of the guide rail 47. This results in a particularly low-friction and low-noise drive that runs, in particular, without canting and demonstrates limited wear. Should the ball bearings wear, this will hardly be noticeable inasmuch as each ball bearing only comes into contact with the track 48 on the guide rail 47 once and then the other ball bearing immediately engages with the track 48. Over time, however, one or more ball bearings can wear out and noise is then generated, which is to be recorded by the wear measurement according to the invention.

For this purpose, it is provided that an electronic board 9 is installed in the guide track 6 on one side wall 2 of the linear motor carriage, which electronic board operates with a microprocessor 10 that is optically visible in order to optically distinguish the linear motor carriage 1 from other linear motor carriages for which no wear measurement takes place.

A single sound receiver 11 is preferably arranged in the area of the electronic board 9. A further sound receiver can also be arranged in the opposite housing 12.

It is, however, sufficient to arrange such a sound receiver 11 in a single side wall of a linear motor carriage 1 forming a U-leg, inasmuch as when one of the bearing elements 7, 8 develops noise, the resulting structure-borne and airborne sound is sufficient to apply sufficient sound pressure on the sound receiver 11. As it is located on the inner side of the U-leg of the linear motor carriage and is covered on the outside by parts of the linear motor carriage 1 and the guide rail 47, it is well shielded against disruptive ambient noise. The sound receiver 11 always accompanies the linear motor carriage 1 and therefore remains within its noise-protected installation position.

The signals of the microprocessor 10 and of the sound receiver 11 are transmitted onwards to a lateral connector housing 13 on the outside of the U-shaped leg, in which a communication interface and an associated connector are arranged to enable a standardized interface for signal transmission.

It is preferable if the microprocessor 10 evaluates the signals from the sound receiver 11 and only transmits a signal to the communication interface in the connector housing 13 when a triggering of an alarm occurs. The microprocessor therefore only has one message or alarm output and can therefore be configured in a particularly simple and reliable manner.

Accordingly, FIG. 2 shows that all eight bearing elements 7, 8 can be taken into account as sources of sounds 15 for the sound pressure recording of the sound receiver 11.

FIG. 4 shows a cross-section according to line A-A in FIG. 3, wherein in FIG. 3, the same parts as in FIG. 2 are labeled. FIG. 4 shows that there is a guide groove 16 which interacts with the aforementioned tracks 48 of the guide rail 47. FIG. 4 moreover also shows that the ball bearings 52 run on ball bearing tracks which are aligned in the longitudinal direction, which is to say, in the direction of displacement of the arrows 49, 50. Single-row ball bearing tracks can be provided or also double-row tracks, with which the ball bearings 52 are arranged one above the other and parallel to each other. This is only shown schematically in FIG. 4.

The block diagram in FIG. 5 will now be elucidated in more detail with reference to FIG. 6a and FIG. 6b, wherein it can be seen that a sound pressure meter 17, which is preferably configured as a microphone, picks up the airborne sound and/or structure-borne sound in the area of the inner side wall 2 of the linear motor carriage 1 and feeds it into a sound power module 19 as an electrical signal via the signal path 18. Only the sound power is measured in the sound power module 19 and is inputted into a calculation module 21 via path 20.

A reference module 22 is arranged on the opposite side of the calculation module 21, which reference module feeds a specific electrical reference value into the calculation module 21 via path 23 and the resulting value at path 24 corresponds to curve 24a in FIG. 6a.

The sum value determined by the calculation module 21 is inputted via the path 24 to an integrator 25, which forms integrals 36, 39, 44 above or below the reference sound power 53 in accordance with the curve FIG. 6a. This means that, starting from a zero position 34, the curve 24a rises inasmuch as the recorded sound power rises and goes on to a position 35 where the reference sound power 53 is exceeded. When the reference sound power 53 is exceeded, integration begins in the form of the integral surface 36.

The integral surface 36 resulting above the reference sound power 53 is considered a sign of wear, whereas the integral surfaces 39 resulting below the reference curve 53 do not represent wear. In this manner, a temporary overload situation on the basis of noise development is permissible, for example, at very high speeds or if an external noise would have an influence. So that this does not lead directly to the triggering of an alarm, the integral surfaces 39 are subtracted from the upper integral surfaces 36, 42, 44 and are then all added together as shown in FIG. 6b, resulting in a summation curve 38. In this way, from position 35 in FIG. 6b, the summation curve 38 will increase and inasmuch as the sound power decreases in the space between position 37 and position 40, the summation curve will decrease and even approach zero at position 40.

This is a significant advantage of the wear measurement according to the invention, inasmuch as temporary noise increases do not trigger the wear measurement, but rather lead to a decrease in the summation curve 38. It is a self-correcting system, which only leads to the triggering of an alarm if the noise development continues, as shown, for example, by the progressing curves in FIG. 6a and FIG. 6b. If the external noise development at integral surface 39 decreases, an integral surface 42 indicating the overload is once again generated at position 41, which leads to a repeated summation of curve 38 in FIG. 6b, wherein integral surfaces 39′ are then naturally also subtracted again and, ultimately, the integral surface 44 leads to such a strong increase in the summation curve 38 that, at position 45, it leads to a triggering of an alarm 46 inasmuch as the maximum value 54 was exceeded.

The special evaluation can be seen in FIG. 5, inasmuch as the summation curve 38 comes into being at the output of the integrator 25 at path 26. The summation curve 38 is compared in the comparator module 27 with the maximum permissible sound energy via path 28 with the maximum value 54 in a reference module 29. If the maximum value 54 is exceeded, the triggering of the alarm then takes place in warning module 31 via path 30.

Overall, therefore, in FIG. 6, the sound power 32 is recorded over the time axis 33 and if the reference sound power 53 is exceeded, an integration that is configured by counting up and down takes place, depending on whether the reference sound power 53 is exceeded or undershot.

This is a significant advantage when compared to the state of the art inasmuch as it is a simple, continuously running system that compensates for external noise emissions and works in a particularly reliably manner.

### DRAWING REFERENCES

1. Linear motor carriage
2. Side wall
3. Winding surface
4. Winding housing
5. Guide track
6. Guide track
7. Bearing element
8. Bearing element
9. Electronic board
10. Microprocessor
11. Sound receiver
12. Housing (end stop)
13. Connector housing
14. Base plate
15. Sources of sounds
16. Guide groove
17. Sound pressure meter
18. Signal path
19. Sound power module
20. Path
21. Calculation module
22. Reference module
23. Path
24. Path (result)
24a) Curve
25. Integrator
26. Path
27. Comparison module
28. Path
29. Reference module (maximum)
30. Path
31. Warning module
32. Sound power
33. Time axis
34. Position
35. Position
36. Integral surface (positive)
37. Position
38. Summation curve
39. Integral surface (negative)
40. Position
41. Position
42. Integral surface
43. Summation curve
44. Integral surface
45. Position
46. Triggering of alarm
47. Guide rail
48. Tracks
49. Arrow directions
50. Arrow directions
51. Permanent magnets
52. Ball bearing
53. Reference sound power
54. Maximum value

1. A method for fault prevention in electric drives in industrial automation, comprising the steps of:
recording sound level signals on the inside of the electric drive during operation with known sound propagation geometry and known distance to the source of sounds,
continuously comparing the sound power with a reference sound power and monitoring of the exceeding of the maximum value of the sound energy,
continuously adding up of the sound power over time when the sound power exceeds the reference sound power,
continuously subtracting the sound power over time when the sound power falls below the reference sound power, with a minimum value of zero,
generating a warning or alarm when the maximum value of the sound energy is exceeded.

2. A method for acoustic wear measurement of electrically driven linear or rotary drives for recording wear-related damage to bearing elements, comprising:
in a first method step, recording the sound power with at least one acoustic sound receiver, in a second method step, the recorded sound power is continuously compared with a maximum permissible reference sound power,
in a third method step, recording a temporary exceeding of the reference sound power, and in a fourth method step, continuously integrating by addition of the sound power recorded in the third method step over time, as long as the sound power exceeds the reference sound power,
in a fifth method step, continuously integrating by subtraction of the sound power recorded in the third method step over time when the sound power falls below the reference sound power, in a sixth method step, summing the additive and subtractive integral surfaces determined in the fourth and fifth method steps to form a summation curve, and
in a seventh method step, issuing a warning message and/or a triggering of an alarm if the summation curve determined in the sixth method step is greater than zero over a specified period of time.

3. The method according to claim 2, wherein the triggering of the alarm in the seventh method step is used to indicate the need for maintenance of the bearing elements.

4. The method according to claim 2, wherein if the triggering of the alarm in the seventh method step lasts for a predetermined period of time which exceeds the period of time for indication of the need for maintenance of the bearing elements, an indication for replacement of the bearing elements is generated.

5. The method according to claim 2, wherein the sound power recorded in the first method step is recorded when the drive is at a standstill in order to record an ambient sound power.

6. The method according to claim 5, wherein the recorded ambient sound power is continuously subtracted from the sound power during operation of the drive.

7. The method according to claim 1, wherein a reference sound power level is defined that corresponds to normal operation and that a maximum sound energy value is defined, above which a warning or alarm is triggered.

8. A device for acoustic wear measurement of the bearing elements of linear electric drives, wherein an electrically energized linear motor carriage is displaceably driven in guide tracks of a stationary guide rail, wherein the linear motor carriage is configured as a U-profile with its side walls at least partially overlapping the guide rail from the outside, and at least one acoustic sound receiver is arranged concealed on the inner side of the side wall of the linear motor carriage.

9. A device for acoustic wear measurement of the bearing elements of rotary electric drives, wherein a rotor with bearing elements is driven in rotation on a shaft of a stator, wherein at least one acoustic sound receiver is arranged on the rotor in the vicinity of the bearing elements.

10. The device according to claim 8, wherein a microprocessor recording and evaluating sound power is arranged in the immediate vicinity of the sound receiver.

11. The device according to claim 10, wherein the microprocessor only generates an output signal if the evaluated sound power leads to the result that lubrication or replacement of the bearing elements is necessary.

12. The device according to claim 9, wherein a microprocessor recording and evaluating sound power is arranged in the immediate vicinity of the sound receiver.

13. The device according to claim 12, wherein the microprocessor only generates an output signal if the evaluated sound power leads to the result that lubrication or replacement of the bearing elements is necessary.
